(19) United States
(12) Patent Application Publication
(10) Pub. No.: US 2010/0200579 A1
(43) Pub. Date: Aug. 12, 2010

(54) PALLET CONTAINER

(75) Inventors: Klaus Peter Schmidt, Bonn (DE); Detlev Weyrauch, Kleinmaischeid (DE); Dietmar Przytulla, Kerpen (DE); Ernst Wurzer, Konigswinter (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Mauser-Werke GmbH, Bruhl (DE)

(21) Appl. No.: 12/760,984

(22) Filed: Apr. 15, 2010

Related U.S. Application Data
(63) Continuation of application No. 12/164,354, filed on Jun. 30, 2008, now abandoned.
Application No. 12/164,354 is a continuation of application No. 11/196,150, filed on Aug. 3, 2005, now abandoned.
Application No. 11/196,150 is a continuation of application No. PCT/EP2005/002039, filed on Feb. 25, 2005.

(30) Foreign Application Priority Data
Feb. 27, 2004 (DE) 20 2004 003 236.8

(51) Int. Cl. B65D 88/00; B65D 6/40; B23P 11/00

(52) U.S. Cl. 220/1.6; 220/601; 29/428

(57) ABSTRACT

A pallet container for the storage and transport of liquid or free-flowing goods, includes a thin-walled inner container of thermoplastic material, a tubular lattice frame closely surrounding the inner plastic container in the form of a support jacket, and a bottom pallet upon which the inner plastic container rests and with which the tubular lattice frame is securely fixed. The inner plastic container includes for withdrawal of liquid goods at the lower side, approximately in mid-section in a side wall near its bottom a blown, calibrated tubular pipe for allowing attachment of a closeable discharge fitting which is fixedly welded with its tubular housing to the calibrated tubular pipe of the inner container.

### CROSS-REFERENCES TO RELATED APPLICATIONS

This application is a continuation of prior filed copending U.S. application Ser. No. 12/164,354, filed Jun. 30, 2008 which is a continuation of U.S. application Ser. No. 11/196,150, filed Aug. 3, 2005, the priority of which is hereby claimed under 35 U.S.C. §120 and which is a continuation of prior filed copending PCT International application no. PCT/EP2005/002039, filed Feb. 25, 2005, which designated the United States and on which priority is claimed under 35 U.S.C. §120, and which claims the priority of German Patent Application, Serial No. 20 2004 003 236.8, filed Feb. 27, 2004, pursuant to 35 U.S.C. 119(a)-(d).

The content of U.S. application Ser. Nos. 12/164,354 and 11/196,150 are incorporated herein by reference in its entirety as if fully set forth herein.

### BACKGROUND OF THE INVENTION

The present invention relates, in general, to a pallet container for the storage and transport of liquid or free-flowing goods. The present invention further relates to a method of making such a pallet container.

The structural configuration of such pallet containers is generally known and its essential components are described e.g. in German publication no. DE-A 34 42 701. Typically, discharge fittings are screwed by means of a coupling nut onto an outer thread of the outlet pipe of the inner container; known are however also further weld-on connections for discharge fittings. A pallet container with a discharge fitting welded directly onto the inner plastic container is known, e.g., from German publication no. DE-A 34 42 700. Following the blow-molding process, a bottom-proximal opening is hereby provided in the inner container for insertion of about half of the housing of the discharge fitting and welded against the wall of the inner container.

Further known from the prior art are constructions with pre-fabricated threaded pipes or entire housings for fittings as insert into the opened blow mold with subsequent welding with the plastic container during the blow-molding process. These constructive variations suffer however particular drawbacks:
The placement of the threaded pipe or housing into the blow mold is complicated and not safe,
welding of the insert with the inner container during blow molding process is comparably undefined (no precisely controllable contact pressure),
the through-flow opening in the inner container must be opened subsequently through the pipe or the valve housing (e.g. drilling with respective contamination)
the fitting must be completed on the container (complex);
testing the critical component “fitting” can only be implemented on the container itself.
the constructions with fittings directly welded onto the container wall represent a particular variant which does not allow use of the inner container for threadable fittings; this is e.g. disadvantageous for later reconditioning.

The construction, known from German publication no. DE-A 34 42 700 with attached connection for the discharge fitting by welding, has the following drawbacks:
the fabrication process of the inner container is suited especially to the type of construction of a sliding-type fitting;
the discharge opening is incorporated subsequently into the inner container, i.e. after the blow-molding process but before welding the discharge fitting,
the region of the inner container for welding of the discharge fitting is blown without additional aids, i.e. the thin wall thicknesses result from the blowing process and are subject to the typical fluctuations with insufficient reproducibility and slight stability (bending strength),
the construction of the inner container represents a special variant which is not applicable for fittings that can be screwed on.

European publication no. EP-A 0 704 385 discloses a pallet container in which the threaded pipe is placed as pre-fabricated injection-molded part into the blow mold and welded onto the inner plastic container, wherein the discharge fitting is subsequently screwed on by means of a coupling nut.

It would therefore be desirable and advantageous to provide an improved pallet container to obviate prior art shortcomings and to construct a pallet container with an inner container that allows cost-efficient manufacturing of the connection for a discharge fitting and has a particularly high load-bearing capability (bending strength) when the discharge fitting is handled for withdrawing goods.

### SUMMARY OF THE INVENTION

According to one aspect of the present invention, a pallet container for the storage and transport of liquid or free-flowing goods, including a thin-walled inner container of thermoplastic material, a tubular lattice frame closely surrounding the inner plastic container in the form of a support jacket, and a bottom pallet upon which the inner plastic container rests and with which the tubular lattice frame is securely fixed, wherein the inner plastic container includes for withdrawal of liquid goods at a lower side, approximately in mid-section in a side wall near the bottom plate a blown, calibrated tubular pipe for allowing attachment of a closeable discharge fitting wherein the discharge fitting is fixedly welded or bonded with its tubular housing to the tubular pipe of the inner container.

The present invention resolves prior art problems by providing a fitting which is fixedly connected to the pipe of the inner container by means of welding or bonding. When a welded connection is involved, various processes can be used, such as hot plate welding, laser welding, friction welding, ultrasonic welding, or vibration welding. Hot plate welding is used in a preferred embodiment because it is very economical while providing easy access to the welding spot. However, also bonding by means of a special plastics adhesive can be executed in a simple and inexpensive manner. In contrast to the use of a coupling nut to screw the discharge fitting connections onto the outlet pipe, a fixed connection has the following advantages:
Higher safety: screw connections and in particular the necessarily used ring seals always pose a risk potential for leakage. Seals used heretofore have either poor sealing capabilities (slight rebound capability, cold flow, high hardness) or no universal chemically resistance (aging, brittleness);
Threadable connections with components of plastic (here in any event the outlet pipe) are subject to a decrease of the tightening moment in view of the cold flow and thus may become leaky;
Less costs: When fixedly connected by means of bonding or welding, the need for the coupling nut and the ring seal is eliminated (cost savings);
The discharge fitting is connected with the inner container preferably in complete and pre-checked conditions.

Hereby, all types of constructions of discharge fittings, such as e.g. flap valve, sliding valve, ball valve, etc, may advantageously be applicable.

The connection during welding (or bonding) of fitting and inner container is implemented after the blow molding process on the cooled inner plastic container in a separate working step under reproducible, controlled joining conditions such as, e.g. optimum joining time, joining temperature, joining pressure, etc.

In contrast to threads simply blown onto blow-molded parts (imprecise thread formation, poor reproducibility), calibrated threaded pipes have good reproducibility with exact formation of the outer thread turns (just like in an injection molding process) because the threaded pipe is held on the inside on the blow pin and the thread is pressed and formed on the outside by a split threaded calibration piece in the mold partition plane of the two-part blow mold or a respective mold slide.

The components inner container and fitting have the following features:
The inner container with outlet pipe attached by calibration does not require additional finishing works of the inner container to produce the discharge opening; this is realized during the blowing process itself.
Defined wall thicknesses (outer and inner contours defined by mold insert or blow pin needle, respectively) can be realized in the outlet pipe.
In the region of the outlet pipe, reproducibly limited, increased wall thicknesses of the inner container can be realized, combined with gain in strength and gain in material for the subsequent welding. The direct contact surface for welding can be configured substantially freely and can be optimized for welding.
During welding operation (or bonding operation), the calibrated threaded pipe is held in a tongs-like fixing device having two semi-shells with internal thread for precise engagement in the outer thread of the outlet pipe, so that a high contact pressure can be applied during welding.

According to another feature of the present invention, the contact surface of the blown outlet pipe (with outer thread) for the welding may be provided with inwardly descending slant, thereby realizing a better melting of the plastic material.

According to another feature of the present invention, the contact surface of the blown outlet pipe (e.g. with flanged rim) for the welding may be configured of flat design. Advantageously, the outer contour of the calibrated pipe is hereby configured such that a secure mechanical resistance is established for applying the required mechanical joining pressure for some welding processes (e.g. hot plate welding).

The welded connections eliminate the ring seal and coupling nut; they represent a significantly lesser error source for leakage because the typically used ring seal ages very often or is attacked by aggressive contents (e.g. swelling, embrittling).

According to another feature of the present invention, the contact surface of the calibrated outlet pipe may be provided with a screw thread (universal pipe!).

During welding operation, a tool for securing the outlet pipe engages its outer thread so that a high joining pressure can be applied when welding the tubular connection piece of the discharge fitting.

These thus-configured inner containers can thus be used for screwed-on or welded-on discharge fittings. The following advantage results hereby: Weld-on discharge fittings can be removed during reconditioning through simple mechanical separation of the fixedly interconnected components outlet valve and inner container and very easily replaced for further utilization by a screwed-on fitting with seal and coupling nut, as practiced currently in typical pallet containers.

The discharge fitting according to the invention of plastic is preferably configured with extended inlet pipe having a diameter (external e.g. 62.5 mm) which is as closely suited as possible to the inner diameter of the outlet pipe (about 63.5 mm) so as to allow a precision fit and problem-free joining with optimum material fusion on the welding surfaces. The outlet pipe has a length of about 20 to 50 mm, preferably about 35 mm.

The extended inlet pipe (about 20 to 40 mm, preferably about 30 mm) resists encountered forces during mechanical loads when tested (in particular drop test) and application (attachment of hose connections or other couplings on the discharge fitting) and relieves thereby the welded connection (high bending strength). The configuration of the discharge fitting is designed in the area of welding (inlet pipe and welding flange) preferably such that the same fitting construction with respective coupling nut and seal can find application as threadable fitting.

The round connection piece of the discharge fitting with welding flange is welded to the end surface of the outlet pipe calibrated onto the inner plastic container. This end surface of the outlet pipe is preferably slanted from outside inwardly so that the slanted tip of the slant is initially melted during welding to thereby compensate tolerances of the outlet pipe as caused during blow molding. The outer contour of the calibrated pipe with flange rim or outer thread is configured such that a secure mechanical resistance is established for applying the necessary mechanical joining pressure for the welding operation.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a side elevation of a pallet container according to the present invention;

FIG. 2 is a longitudinal section of a discharge fitting for use in the pallet container;

FIG. 3 is a front view of a discharge fitting;

FIG. 4 is a longitudinal section of the discharge fitting, taken along the line A-A in FIG. 3;

FIG. 5a is a side view of the discharge fitting before welding;

FIG. 5b is a side view of the discharge fitting after welding; and

FIG. 6 is a perspective view of the discharge fitting

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

Turning now to the drawing, and in particular to FIG. 1, there is shown a side elevation of a pallet container according to the present invention, generally designated by reference numeral 10. The pallet container 10 has a thin-walled inner container 12 of thermoplastic material, a tubular lattice frame 14 closely surrounding the inner plastic container 12 as support jacket, and a bottom pallet 16 on which the inner plastic container 12 rests and with which the tubular lattice frame 14 is securely connected. The inner plastic container 12 includes for withdrawal of liquid goods at the lower side, approximately in mid-section in a side wall near its bottom a blown, a calibrated tubular pipe 18 with outer thread 20 for allowing attachment of a closeable discharge fitting 22. The pipe 18 may, however, also be provided with a flange rim on which the discharge fitting 22 is secured by means of a tensioning clamp, wherein the discharge fitting 22 may be designed as flap valve, sliding valve, or ball valve.

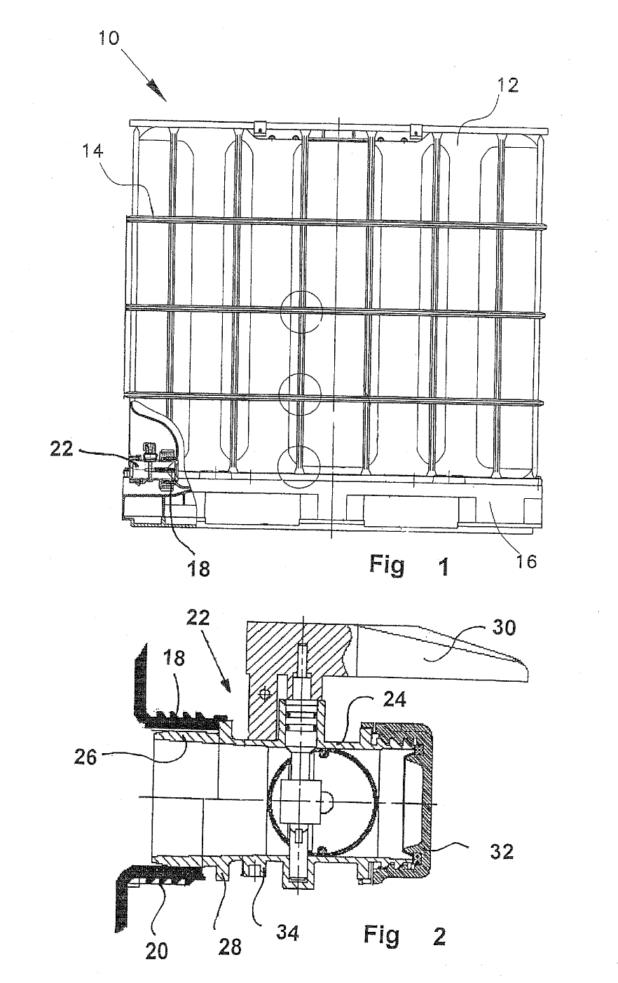

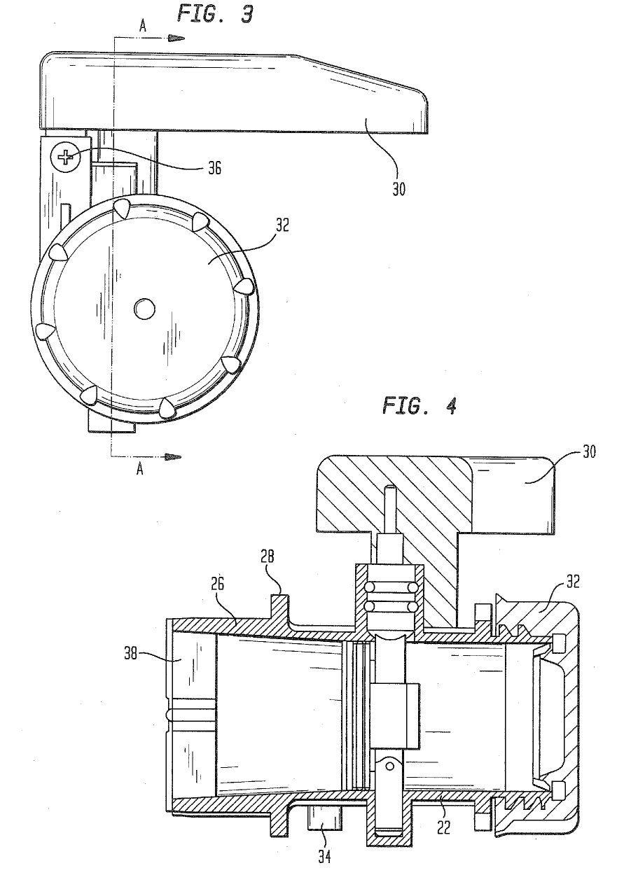

The discharge fitting 22, which is shown in greater detail in FIG. 2, is made substantially of plastic and equipped according to an exemplified embodiment with a flap valve closure, actuatable by a rotary grip 30, and is closed on the outside with a screw cap 32. The discharge fitting 22 has a housing 24 which is provided on the container side with an inlet pipe 26 which is inserted at precision fit in the pipe 18 up to its flange ring 28. In the lower half of FIG. 2, the pipe 18 with outer thread 20 is slightly set back in relation to the flange ring 28 (situation before welding), while the upper half of FIG. 2 shows the pipe 18 bearing upon the flange ring 28 of the housing 24 of the discharge fitting 22 and securely welded therewith (situation after welding).

In view of a good accessibility and optimum geometries of welding spots, the cost-efficient hot plate welding process is preferably used for the welding operation. The discharge fitting is hereby welded onto the outlet pipe in a complete and pre-checked state. The inner container, withdrawn from the blow mold, does not require any refinishing of the pipe for the welding operation.

The thin-walled inner plastic container 12 typically has a mean wall thickness of about 3 mm, while the calibrated pipe 18 for the discharge fitting 22 has a wall thickness of about 5 mm, when a configuration with an inner diameter of about 63 mm is involved. The constructive advantages of the configuration according to the invention are as follows: calibrated pipe with proper material thickness for welding and joining contour; standard pipe with outer thread for attachment of the respectively desired discharge fitting by screwing or welding; long inlet and relief pipes on the fitting with high load-bearing capability for bending stress during frequent operation of the rotary valve.

For viscous goods, pipes and discharge fittings of greater nominal width or greater diameter of about 80 mm or even 120 mm to 150 mm may be provided. Hereby, it is shown: the greater the diameter, the better and safer a fixed connection (welded or bonded) of pipe and discharge fitting in comparison to a conventional screw connection.

FIG. 3 is a front view of the discharge fitting 22, showing in particular the front screw cap 32 and the rotary grip 30. FIG. 4 shows a longitudinal section along the line A-A of this discharge fitting 22. A support device 38, which is prefabricated as a separate injection-molded part and includes an annular outer rim and a star-shaped or cross-shaped inner part, is inserted on the container-side securely into the inlet pipe 26 of the discharge fitting 22. This cross-shaped support device 38 (injection-molded plastic part with fiber reinforcement) is provided to prevent the pipe 18 from assuming an oval shape which could potentially occur as a result of warping or shrinkage, when the inner plastic container unevenly cools down in this region.

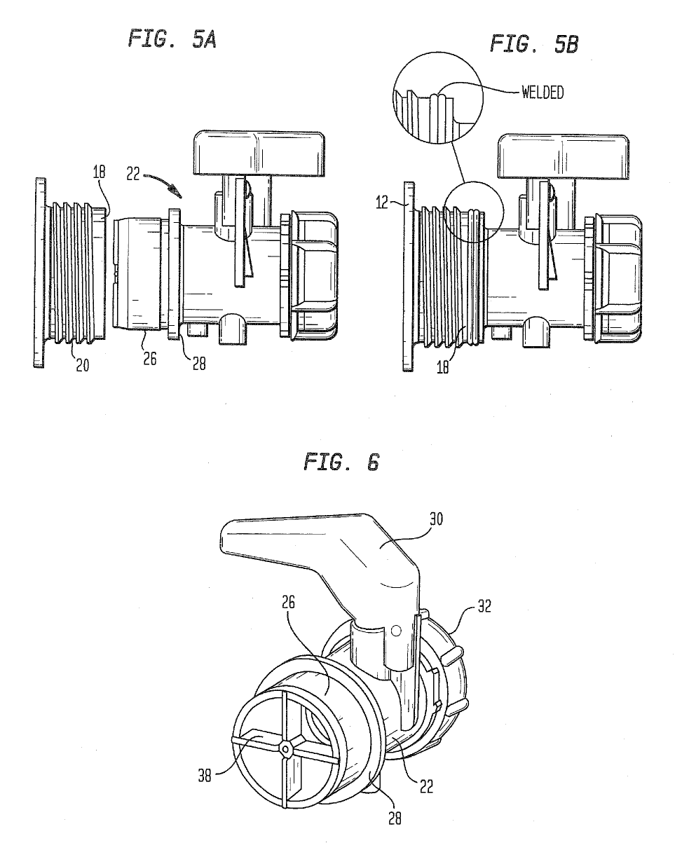

FIG. 5a shows again the container pipe 18 with outer thread 20 and the discharge fitting 22 before insertion and before welding, whereas FIG. 5b shows the welded state. The inlet pipe 26 is hereby pushed into the pipe 18 up to the flange ring 28, and the end surface of the pipe is fixedly welded to the flange ring 28. Refinishing work of the welded seam is hereby not necessary.

FIG. 6 shows again by way of perspective view the cross-shaped support device 38 which is arranged in the inlet pipe 28 and extends transversely to the diameter and which is configured here in one piece and integrated in the housing 22 of the discharge fitting 22.

In accordance with a particular variation, the pallet container is provided for use in potentially explosive zones or for use with combustible goods; in this case, the inner container is configured antistatically or electrically diverting on the outside, and the housing of the discharge fitting is also made of electrically conductive plastic and provided with a connection 34 for threaded attachment of a ground cable (compare FIG. 2).

The particular advantage of this present invention resides also in the fact that a “normal” inner plastic container with calibrated pipe 18 and outer thread 20 is used for welding the discharge fitting thereto; there are no modifications necessary on the blow mold or the blown part (inner container). Thus, customer's desires can easily be satisfied, regardless whether a pallet container is desired with typical discharge fitting which is screwed on by means of a coupling nut or is fixedly welded in. Also, a pallet container with fixedly welded discharge fitting can be reused again. Reconditioning requires only a simple separation of the welded discharge fitting, an internal milling of the pipes, and a new fitting can be screwed on or welded in.

A pallet container with welded discharge fitting can be used for almost any aggressive goods because there is no need to consider the susceptibility of the seal that is no longer necessary.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A pallet container for the storage and transport of liquid or free-flowing goods, comprising a thin-walled inner container of thermoplastic material, a tubular lattice frame closely surrounding the inner plastic container in the form of a support jacket, and a bottom pallet upon which the inner plastic container rests and with which the tubular lattice frame is securely fixed, wherein the inner plastic container includes for withdrawal of liquid goods at a lower side, approximately in mid-section in a side wall near the bottom plate tubular pipe for allowing attachment of a closeable discharge fitting, wherein the discharge fitting is fixedly welded or bonded with its tubular housing to the tubular pipe of the inner plastic container.

2. The pallet container of claim 1, wherein the discharge fitting is welded by means of a process selected from the group consisting of hot plate welding, laser welding, friction welding, ultrasonic welding, or vibration welding, to the tubular pipe of the inner plastic container.

3. The pallet container of claim 1, wherein the housing of the discharge fitting is designed on the side of the inner plastic container as extended tubular inlet pipe with a circumferential flange ring, wherein the inlet pipe is inserted into the tubular pipe of the inner plastic container, and the flange ring is welded to an end surface of the tubular pipe.

4. The pallet container of claim 1, wherein the housing of the discharge fitting is designed on the side of the inner plastic container as extended tubular inlet pipe with a circumferential flange ring, wherein the inlet pipe is inserted into the tubular pipe of the inner plastic container, and the flange ring is bonded to an end surface of the tubular pipe.

5. The pallet container of claim 1, wherein the tubular pipe of the inner plastic container is provided with an outer thread and has a length of about 20 mm to 50 mm.

6. The pallet container of claim 5, wherein the tubular pipe has a length of about 35 mm.

7. The pallet container of claim 1, wherein the housing of the discharge fitting is designed on the side of the inner plastic container as extended tubular inlet pipe with a circumferential flange ring, wherein the inlet pipe of the discharge fitting has a length of about 20 mm to 40 mm up to the flange ring.

8. The pallet container of claim 7, wherein the inlet pipe of the discharge fitting has a length of about 30 mm up to the flange ring.

9. The pallet container of claim 1, wherein the tubular pipe of the inner plastic container has a slant at its end surface.

10. The pallet container of claim 7, wherein the inlet pipe of the discharge fitting has integrated therein a support device extending transversely to a diameter of the inlet pipe.

11. The pallet container of claim 10, wherein the support device is prefabricated as separate injection-molded part and has a ring-shaped outer rim which is securely received in the inlet pipe of the discharge fitting.

12. The pallet container of claim 1, wherein the housing of the discharge fitting is made of electrically conducting plastic and is provided with a connection for a screwed attachment of a ground cable.

13. A pallet container for the storage and transport of liquid or free-flowing goods, comprising:
a bottom plate;
an inner container made of thermoplastic material and resting on the bottom plate, said inner container having a side wall formed with a tubular pipe approximately in mid-section thereof near the bottom plate;
a tubular lattice frame closely surrounding the inner plastic container and securely fixed to the bottom plate; and
a closeable discharge fitting non-detachably connected to the tubular pipe of the inner container.

14. The pallet container of claim 13, wherein the discharge fitting is welded to the tubular pipe.

15. The pallet container of claim 13, wherein the discharge fitting is bonded to the tubular pipe.

16. A method of making a pallet container for the storage and transport of liquid or free-flowing goods, comprising a thin-walled inner container of thermoplastic material, a tubular lattice frame closely surrounding the inner plastic container in the form of a support jacket, and a bottom pallet upon which the inner plastic container rests and with which the tubular lattice frame is securely fixed, wherein the inner plastic container includes for withdrawal of liquid goods at a lower side, approximately in mid-section in a side wall near the bottom plate a tubular pipe for allowing attachment of a closeable discharge fitting, wherein the inner plastic container is held by a correspondingly shaped holding device which attaches to the tubular pipe, and a housing of the discharge fitting is configured with an extended tubular inlet pipe with circumferential flange ring for insertion into the tubular pipe up to the flange ring, and the end surface of the tubular pipe is welded or bonded to the flange ring by applying a respective joining pressure upon both parts.

17. The method of claim 16, wherein the discharge fitting is connected to the inner container in a complete and pre-checked state.

18. A method of making a pallet container for the storage and transport of liquid or free-flowing goods, comprising the steps of:
placing a support device in a tubular pipe of an inner container of thermoplastic material;
providing a discharge fitting with a tubular inlet pipe having a circumferential flange ring;
inserting the inlet pipe of the discharge fitting into the tubular pipe until the flange ring bears against the tubular pipe; and
non-detachably connecting the flange ring to an end surface of the tubular pipe.

19. The method of claim 18, wherein the flange ring is welded to the end surface of the tubular pipe.

20. The method of claim 18, wherein the flange ring is bonded to the end surface of the tubular pipe.

21. The pallet container of claim 1, wherein the inner plastic container and the tubular pipe are of single-piece construction.
